(19) United States
(12) Patent Application Publication
(10) Pub. No.: US 2004/0225797 A1
(43) Pub. Date: Nov. 11, 2004

(54) Shielded routing topology for high speed modules

(76) Inventor: Terry R. Lee, Boise, ID (US)

Correspondence Address: DICKSTEIN SHAPIRO MORIN & OSHINSKY LLP, 2101 L STREET NW, WASHINGTON, DC, 20037-1526, US

(21) Appl. No.: 09/887,021

(22) Filed: Jun. 25, 2001

(51) Int. Cl. G06F 13/00

(52) U.S. Cl. 710/301

(57) ABSTRACT

A bus routing topology for a bus system in which every pair of signal lines are provided with shielding is provided, thereby effectively limiting signal cross-talk to only one signal pair while minimizing the number of pins required on a connector. Further, if these signals are a differential signal pair, then the coupling can be beneficial from the standpoint of signal integrity. By shielding only every pair of signal lines, the number of connector pins is significantly reduced, thus reducing the size and cost of the connector and module on which the connector is provided.

### FIELD OF THE INVENTION

The present invention relates generally to the field of computer systems, and more particularly to a bus routing topology for high data rate modular systems.

### BACKGROUND OF THE INVENTION

Today's computer and network systems require the ability to expand their hardware over time to improve their performance or to accommodate new users. Expansion capabilities are typically provided for graphics, input/output (I/O), network interface, microprocessors, static random access memory (SRAM) and dynamic random access memory (DRAM) circuit cards. These expansion cards are typically mounted on a printed circuit board (PCB) that can easily be inserted or removed by a user of the system. The PCB is inserted into a connector, which provides an electrical connection to a bus.

The expandable bus is typically located on a host PCB, often referred to as a motherboard. Connectors are mounted on the motherboard to provide slots for hardware expansion. The bus connects to the expansion card through the connector. Expansion cards are also known as add-in cards. This connection typically results in a branch off the main bus to the receiving components on the expansion card. This branch is commonly referred to as a stub connection.

FIG. 1 illustrates a conventional high speed bus system 10, typically used in network switches, hubs and computer systems. This system 10 is often referred to as a stub bus system. The system 10 includes two circuit cards 30, 40 that are attached to bus lines B₁, B₂, B₃, B₄ through connectors 14, 16, respectively. The point where the bus lines B₁, B₂, B₃, B₄ branch off into the connectors are the stub connection points S₁, S₂, S₃, S₄, S₅, S₆, S₇, S₈ (collectively referred to herein as stub connections S). The bus lines B₁, B₂, B₃, B₄ may comprise the main computer bus B for the system 10 or a sub-bus. Each bus line B₁, B₂, B₃, B₄ may be a 16-bit wide bus line, making the bus B a 64-bit bus. If the illustrated circuit cards 30, 40 are memory modules, a memory controller 12 is typically connected to the bus lines B₁, B₂, B₃, B₄ and manages data flow on the bus B. The controller 12, bus lines B₁, B₂, B₃, B₄ and connectors 14, 16 all reside on the computer motherboard. The circuit cards 30, 40 contain circuit elements 32, 42, respectively, which for this example are memory chips.

In the present example, each connector 14, 16 (also referred to as a slot) is provided for increasing the memory storage capacity of the system 10. Although only two connectors 14, 16 are illustrated, there can be any number of connectors 14, 16. Typically, the number of slots will be determined by the maximum bus B operating frequency or by the maximum desired memory capacity. In the present example, the connectors 14, 16 can be 184-pin dual in-line memory module (DIMM) connectors and the cards 30, 40 can be double data rate (DDR) synchronous DRAM (SDRAM) modules.

The stubs S1-S8 are electrically undesirable for high-speed buses, however, since they provide a discontinuity of impedance along the bus B, which results in reflected energy on the bus B. Thus, for high-speed modular buses, it is desirable to reduce the effect of the stubs that connect the devices on the bus to the bus itself to improve signal integrity, and therefore the maximum operating frequency of the bus system.

One technique for reducing the effect of the stubs on the bus is to remove the stub connection points. FIG. 2 illustrates a conventional system 50 where the bus B is looped through a connector 52, circuit card 54 and then back out on a different pin on the same connector 52. This system 50 is often referred to as a loop-through bus system. Keeping with the above example illustrated in FIG. 1, the system 50 may be used as a computer main memory subsystem. The system includes a memory controller 56 that is mounted on the computer motherboard along with the bus B and connector 52. Card 54 contains one or more circuit elements 58, which for this example are memory chips. The bus B may be a 16-bit or wider bus.

By eliminating the stub connections, the loop-through bus system improves the operating bandwidth. However, if a single connector 50 is used for each circuit card 60, the number of pins on connector 50 is doubled in this type of system 50 versus a stubbed system 10 as illustrated in FIG. 1.

Operating bandwidth of the bus B can also be improved by reducing the signal cross-talk of proximate signals on the bus, thus reducing the timing uncertainty of signal arrivals and allowing a higher maximum operating frequency. One technique that is used to reduce signal cross-talk is to provide a ground or reference shield next to each signal line on the bus as illustrated in FIG. 3. As shown in FIG. 3, the signal lines B0, B1 and B2 (three-bits of bus B) are looped through a connector 52, circuit card 54 and then back out on a different pin on the same connector 52 similarly as illustrated in FIG. 2. A ground shield 60 is provided on each side of the signal lines (only illustrated on each side of B1 in FIG. 3 for clarity). The shield 60 provides a coupling path from the signal line B1 to ground, as opposed to the adjacent signal lines B0 and B2. Accordingly, the pins 62 of connector 52 would be alternating between a signal line and ground, i.e., signal B0, ground, signal B1, ground, signal B2, ground, etc. as illustrated in FIG. 3.

While the use of grounding shields 60 reduces signal cross-talk between adjacent signal lines on the bus, it almost doubles the number of pins required on the connector as compared with the loop-through bus as illustrated in FIG. 2. Accordingly, the number of connector pins in the shielded system is approximately quadrupled as opposed to the stub system of FIG. 1. This additional increase in the number of connector pins increases the area occupied by the connector on the motherboard and also increases the cost.

Thus, there exists a need for a routing topology and modular bus connector that provides a high speed bus system without significantly increasing the number of pins required on the connector.

### BRIEF SUMMARY OF THE INVENTION

The present invention alleviates the problems of the prior art and provides a routing topology and connector for a bus system that reduces signal cross-talk while minimizing the number of pins required on the connector.

In accordance with one aspect of the present invention, a routing topology is provided for a bus system in which every pair of signal lines are provided with shielding. In this manner, signal cross-tall( is effectively limited to only one signal pair while minimizing the number of pins required on a connector. Further, if these signals are a differential signal pair, then the coupling can be beneficial from the standpoint of signal integrity. By shielding only every pair of signal lines, the number of connector pins is significantly reduced, thus reducing the size and cost of the connector and module on which the connector is provided.

These and other advantages and features of the invention will become more readily apparent from the following detailed description of the invention which is provided in connection with the accompanying drawings.

### BRIEF DESCRIPTION OF THE DRAWINGS

The above and other features and advantages of the invention will be more readily understood from the following detailed description of the invention which is provided in connection with the accompanying drawings.

FIG. 1 illustrates an exemplary conventional stub bus topology;

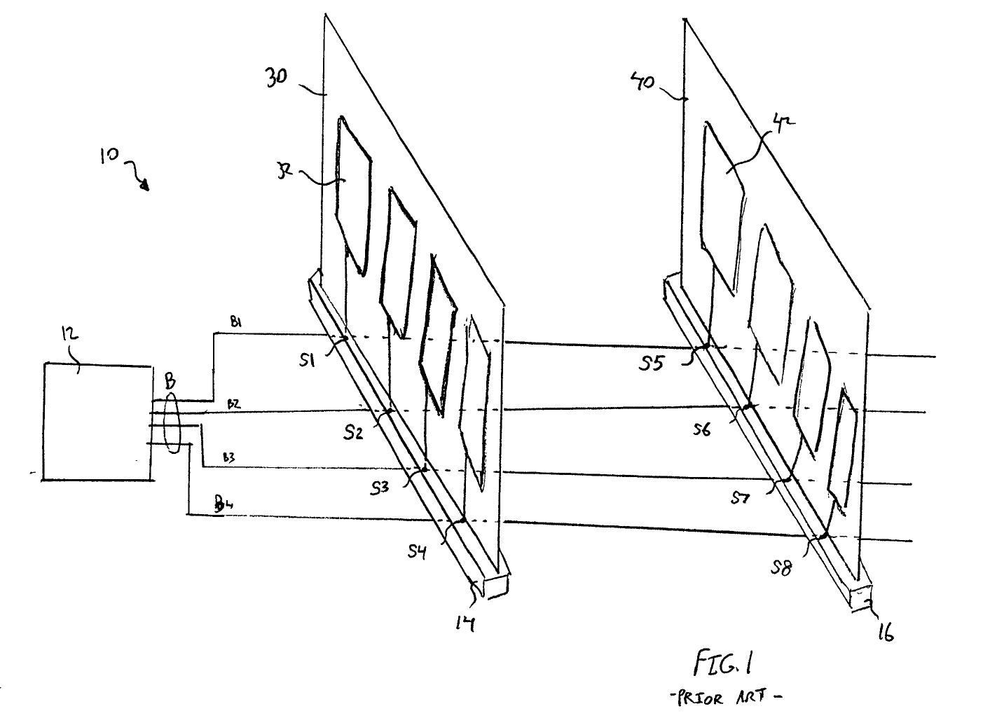

FIG. 2 illustrates an exemplary conventional loop-through bus topology;

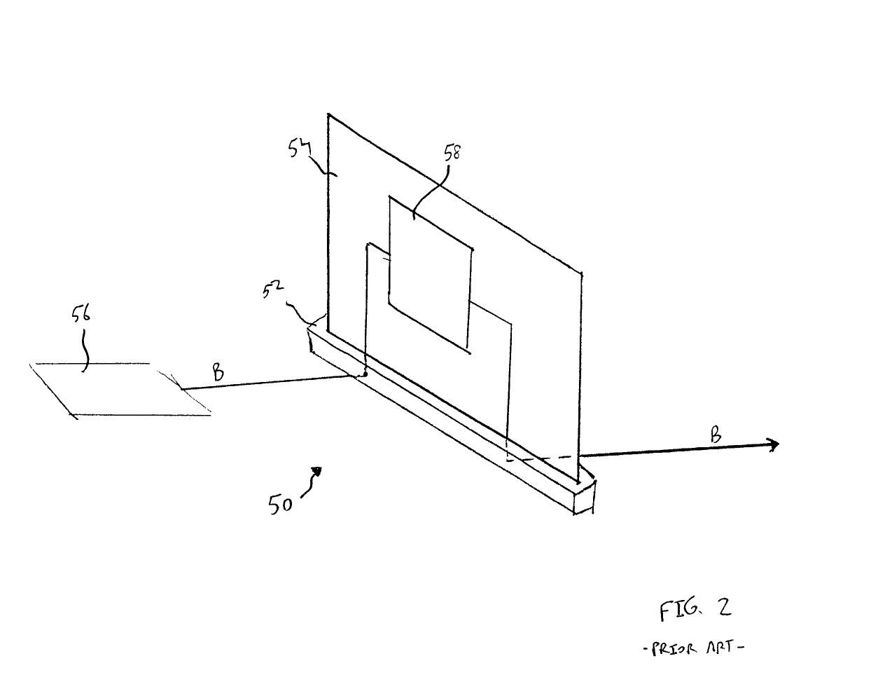

FIG. 3 illustrates a circuit card having an exemplary conventional loop-through bus topology with shielding provided for every signal line;

FIG. 4 illustrates a circuit card having a loop-through bus topology with shielding on every pair of signal lines in accordance with the present invention;

FIG. 5 illustrates another circuit card having a bus topology with shielding on every pair of signal lines in accordance with the present invention; and

FIG. 6 illustrates in block diagram form a processor controlled system in which a circuit card having a loop-through bus topology with shielding on every pair of signal lines according to the present invention is employed.

### DETAILED DESCRIPTION OF THE INVENTION

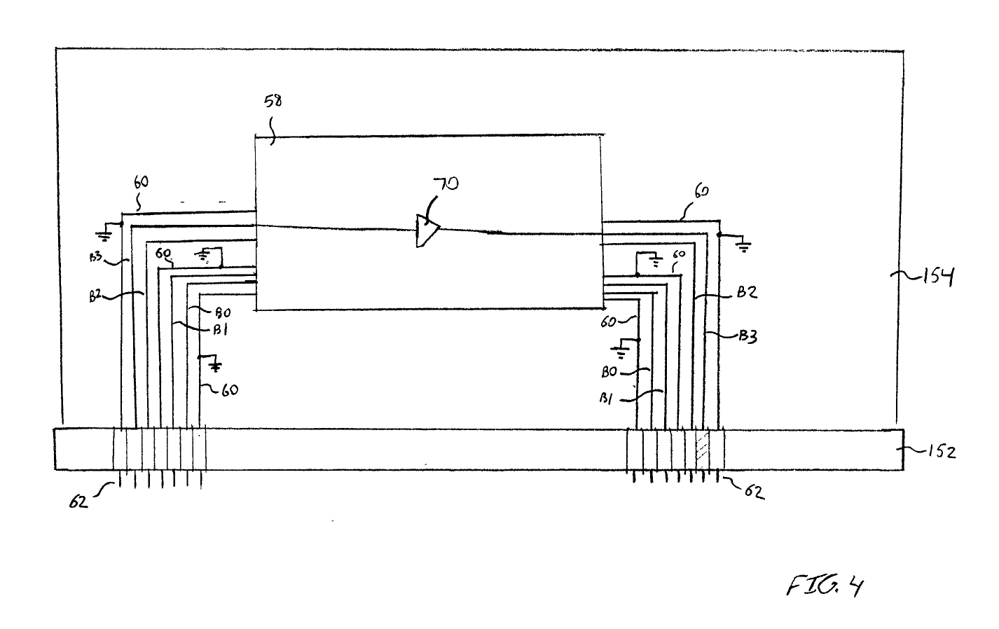

The present invention will be described as set forth in the preferred embodiments illustrated in FIGS. 4-6. Other embodiments may be utilized and structural or logical changes may be made without departing from the spirit or scope of the present invention. Like items are referred to by like reference numerals.

In accordance with the present invention, a connector is provided for a bus system in which every pair of signal lines are provided with shielding, thereby effectively limiting signal cross talk to only one signal pair while reducing the number of connector pins required. Further, if these signals are a differential signal pair, then the coupling can be beneficial from the standpoint of signal integrity.

FIG. 4 illustrates a circuit card 154 having a loop-through bus topology with shielding on every pair of signal lines in accordance with the present invention. As shown in FIG. 4, the signal lines B0, B1, B2 and B3 (four bits of bus B) are looped through a connector 152, circuit card 154 and then back out on a different pin on the same connector 152. A ground shield 60 is provided on each side of a corresponding pair of the signal lines, i.e., on each side of the pair B0 and B1, and each side of the pair B2 and B3. The shields 60 provide a coupling path from the signal lines to ground, except for between the corresponding pairs. Thus, signal cross-talk is effectively limited to only one adjacent neighbor signal of each signal pair, i.e., between signal lines B0 and B1, or between signal lines B2 and B3, but not between signal lines in different pairs.

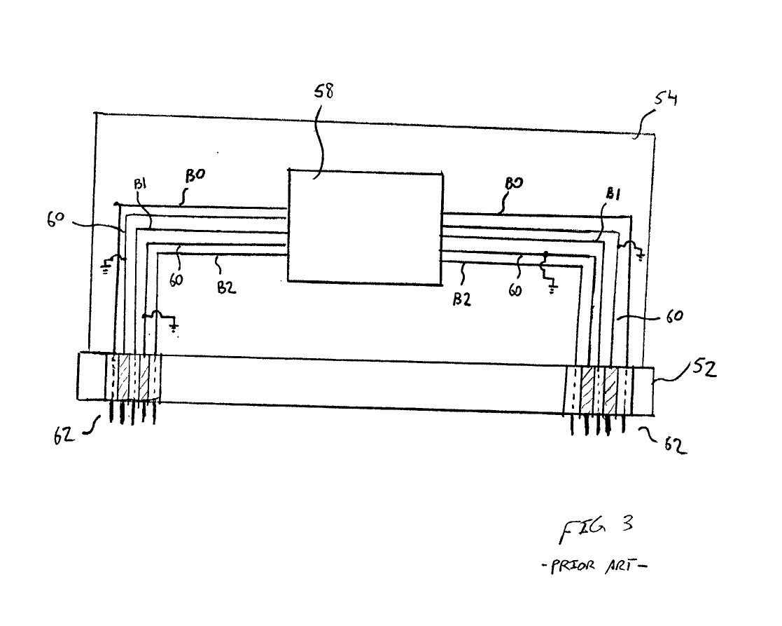

Accordingly, the pins 62 of connector 152 would be alternating between a pair of signal lines and ground, i.e., ground, signal B0, signal B1, ground, signal B2, signal B3, ground, etc. as illustrated in FIG. 4. By utilizing the routing topology according to the present invention, the number of pins required for the connector is significantly reduced by approximately 25%. For example, for an eight bit bus, the number of pins required for a connector utilizing the prior art routing topology as illustrated in FIG. 3 would be 34 (17 each for the input and output). The number of pins required for a connector utilizing the present invention as illustrated in FIG. 4 would be 26 (13 each for the input and output).

Furthermore, if the signals in each pair of signal are differential signals, i.e., the signals are assigned as signal+, signal−, ground, signal+, signal−, ground, etc., the complementary signal pair will couple, but the differential signal pairs will not couple significantly with the other signals. The coupling of the complementary signals from each pair can be beneficial and desirable from the standpoint of signal integrity, thereby providing additional benefits of the routing topology as opposed to the prior art.

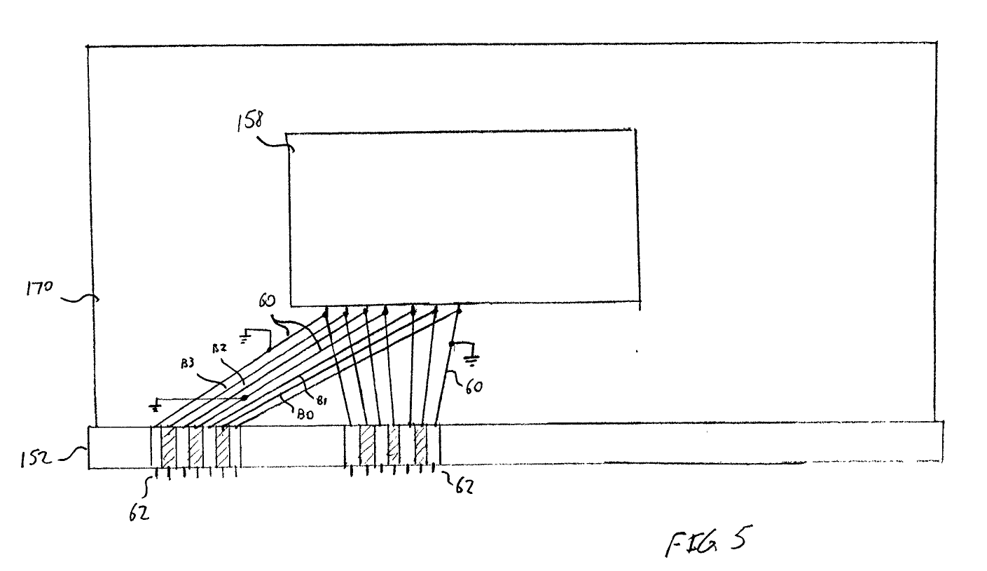

It should be understood that the shielded routing topology according to the present invention can be utilized with bus systems in which the continuity of the bus is provided inside the circuit element itself, i.e., a loop-through bus, as illustrated in FIG. 4 or with bus systems in which the continuity of the bus is provided externally on the circuit card as illustrated in FIG. 5. As shown in FIG. 4, the bus signal enters on one pin of the circuit element 58, such as for example a memory device, and exits on a different pin. An optional bus driver 70 may be provided in series with the bus path to re-drive the bus signal to the exit pin. As illustrated in FIG. 5, the bus signal enters and exits on the same pin of the circuit element 158 and the continuity of the bus system is provided on the circuit card 170. A ground shield 60 is provided on each side of a corresponding pair of the signal lines, i.e., on each side of the pair B0 and B1, and each side of the pair B2 and B3. The shields 60 provide a coupling path from the signal lines to ground, except for between the corresponding pairs. Thus, signal cross-talk is effectively limited to only one adjacent neighbor signal of each signal pair, i.e., between signal lines B0 and B1, or between signal lines B2 and B3, but not between signal lines in different pairs.

Thus, in accordance with the present invention, a routing topology and connector are provided for a bus system in which every pair of signal lines are provided with shielding, thereby effectively limiting the signal cross talk to only one signal pair while reducing the number of connector pins required. Further, if each pair of signals are a differential signal pair, then the coupling can be beneficial from the standpoint of signal integrity.

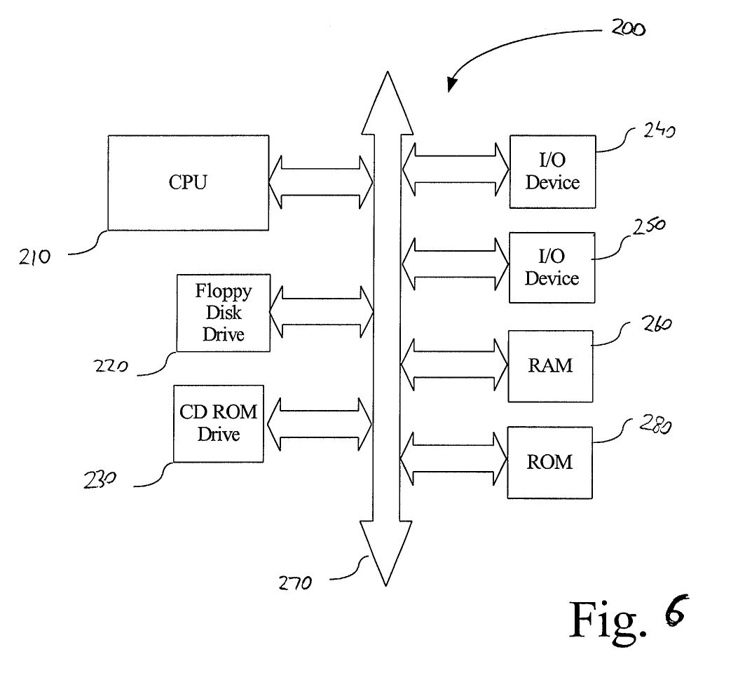

A typical processor based system that includes a memory circuit card 154 having the shielded routing topology according to the present invention is illustrated generally at 200 in FIG. 6. A computer system is exemplary of a system having integrated circuits, such as for example memory circuits. Most conventional computers include memory devices permitting storage of significant amounts of data. The data is accessed during operation of the computers. Other types of dedicated processing systems, e.g., radio systems, television systems, network switches, telephones and telephone systems also contain memory devices which can utilize the present invention.

A processor based system, such as a computer system, for example, generally comprises a central processing unit (CPU) 210, for example, a microprocessor, that communicates with one or more input/output (I/O) devices 240, 250 over a bus 270. The computer system 200 also includes random access memory (RAM) 260, a read only memory (ROM) or Flash memory 280 and, in the case of a computer system may include peripheral devices such as a floppy disk drive 220 and a compact disk (CD) ROM drive 230 which also communicate with CPU 210 over the bus 270. At least one of CPU 210 and one or more integrated circuits connected thereto, such as employed for RAM 260 and ROM 280, are preferably constructed as integrated circuits which include the bus routing topology as previously shown and described with respect to FIG. 4. It may also be desirable to integrate the processor 210 and memory 260 on a single IC chip and have one or both of processor 210 and memory 260 employ the bus routing topology shown and described with reference to FIG. 4.

While preferred embodiments of the invention have been described and illustrated above, it should be understood that these are exemplary of the invention and are not to be considered as limiting. Additions, deletions, substitutions, and other modifications can be made without departing from the spirit or scope of the present invention. Accordingly, the invention is not to be considered as limited by the foregoing description but is only limited by the scope of the appended claims.

What is claimed as new and desired to be protected by Letters Patent of the United States is:

1. A circuit card comprising:
an integrated circuit having a plurality of inputs and a plurality of outputs;
a connector having a plurality of pins; and
a plurality of conductors, each of said plurality of conductors being coupled between one of said plurality of inputs and one of said plurality of pins or one of said plurality of outputs and one of said pins;
said plurality of pins having a first portion for conducting bus signals and a second portion for providing a shield, said pins in said first portion being grouped in a plurality of corresponding pairs, a respective one of said pins in said second portion being located on each side of each of said plurality of corresponding pairs of said first portion of said plurality of pins.

2. The circuit card according to claim 1, wherein said shield is a ground shield.

3. The circuit card according to claim 1, wherein said integrated circuit further comprises:
a driver to drive said signals between said inputs and said outputs of said integrated circuit.

4. The circuit card according to claim 1, wherein said signals in each of said corresponding pairs are differential signals.

5. The circuit card according to claim 1, wherein said integrated circuit is a memory device.

6. A circuit card comprising:
a connector having a plurality of pins;
a plurality of conductors, each of said plurality of conductors being coupled to one of said plurality of pins; and
an integrated circuit having a plurality of inputs and a plurality of outputs, said conductors being coupled between one of said plurality of inputs and one of said plurality of pins or one of said plurality of outputs and one of said plurality of pins;
said plurality of pins having a first portion for conducting bus signals and a second portion for providing a shield, said pins in said first portion being grouped in a plurality of corresponding pairs, a respective one of said pins in said second portion being located on each side of each of said plurality of corresponding pairs of said first portion of said plurality of pins.

7. The circuit card according to claim 6, wherein said shield is a ground shield.

8. A circuit card comprising:
a first plurality of conductive traces to conduct signals, said first plurality of conductive traces being grouped in a plurality of corresponding pairs; and
a second plurality of conductive traces to provide a shield, a respective one of said second plurality of conductive traces being located on each side of each of said plurality of corresponding pairs of said first plurality of conductive traces;
wherein said first plurality of conductive traces are part of a bus system.

9. The circuit card according to claim 8, wherein said shield is a ground shield.

10. The circuit card according to claim 8, wherein said signals in each of said corresponding pairs are differential signals.

11. A memory expansion card comprising:
a memory device having a plurality of inputs and outputs; and
a connector having a plurality of pins, each of said plurality of inputs and output of said memory device being coupled to at least one of said plurality of pins to receive signals from or send signals to said pins of said connector, a first portion of said plurality of pins for conducting signals and a second portion of said plurality of pins for providing a shield, said pins in said first portion being grouped in a plurality of corresponding pairs, a respective one of said pins in said second portion being located on each side of each of said plurality of corresponding pairs of said first portion of said plurality of pins;
wherein said first portion of said plurality of pins is part of a bus system.

12. The memory expansion card according to claim 11, wherein said shield is a ground shield.

13. The memory expansion card according to claim 11, wherein said signals in each of said corresponding pairs are differential signals.

14. The memory expansion card according to claim 11, wherein said connector is adapted for connection to a motherboard.

15. A memory expansion card comprising:
a memory device having a plurality of inputs and a plurality of outputs;
a first plurality of conductive traces to conduct signals to said plurality of inputs or from said plurality of outputs, said first plurality of conductive traces being grouped in a plurality of corresponding pairs; and
a second plurality of conductive traces to provide a shield, a respective one of said second plurality of conductive traces being located on each side of each of said plurality of corresponding pairs of said first plurality of conductive traces;
wherein said first plurality of conductive traces are part of a bus system.

16. The memory expansion card according to claim 15, wherein said shield is a ground shield.

17. The memory expansion card according to claim 15, wherein said signals in each of said corresponding pairs are differential signals.

18. A connector comprising:
a plurality of pins, said plurality of pins having a first portion for conducting signals and a second portion for providing a shield, said pins in said first portion being grouped in a plurality of corresponding pairs, a respective one of said pins in said second portion being located on each side of each of said plurality of corresponding pairs of said first portion of said plurality of pins;
wherein said first portion of pins is part of a bus system.

19. A processing system comprising:
a processing unit; and
a circuit card coupled to said processing unit, said circuit card comprising:
an integrated circuit having a plurality of inputs and a plurality of outputs;
a connector having a plurality of pins; and
a plurality of conductors, each of said plurality of conductors being coupled between one of said plurality of inputs and one of said plurality of pins or one of said plurality of outputs and one of said plurality of pins;
said plurality of pins having a first portion for conducting signals and a second portion for providing a shield, said pins in said first portion being grouped in a plurality of corresponding pairs, a respective one of said pins in said second portion being located on each side of each of said plurality of corresponding pairs of said first portion of said plurality of pins;
wherein said processing system comprises a bus system for passing signals through said processing system and said first portion of said plurality of pins are coupled to said bus system.

20. The processing system according to claim 19, wherein said shield is a ground shield.

21. The processing system according to claim 19, wherein each of said plurality of inputs and plurality of outputs of said integrated circuit are coupled to a plurality of pins of said connector.

22. The processing system according to claim 19, wherein said integrated circuit further comprises:
a driver to drive said signals between said inputs and said outputs of said integrated circuit.

23. The processing system according to claim 19, wherein said signals in each of said corresponding pairs are differential signals.

24. The processing system according to claim 19, wherein said integrated circuit is a memory device.

25. The processing system according to claim 19, wherein said processing unit and said integrated circuit are on a same chip.

26. A processing system comprising:
a processing unit; and
a memory expansion card coupled to said processing unit, said memory expansion card comprising:
a memory device having a plurality of inputs and a plurality of outputs; and
a connector having a plurality of pins, each of said plurality of inputs and said plurality of outputs of said memory device being coupled to at least one of said plurality of pins to receive signals from or send signals to said pins of said connector, a first portion of said plurality of pins for conducting signals and a second portion of said plurality of pins for providing a shield, said pins in said first portion being grouped in a plurality of corresponding pairs, a respective one of said pins in said second portion being located on each side of each of said plurality of corresponding pairs of said first portion of said plurality of pins;
wherein said processing system comprises a bus system for passing signals through said processing system and wherein said first portion of said plurality of pins are coupled to said bus system.

27. The processing system according to claim 26, wherein said shield is a ground shield.

28. The processing system according to claim 26, wherein said signals in each of said corresponding pairs are differential signals.

29. The processing system according to claim 26, further comprising:
a motherboard, wherein said connector is adapted for connection to said motherboard.

30. A processing system comprising:
a processing unit; and
a memory expansion card coupled to said processing unit, said memory expansion card comprising:
a memory device having a plurality of inputs and a plurality of outputs;
a first plurality of conductive traces to conduct signals to said plurality inputs or from said plurality of outputs, said first plurality of conductive traces being grouped in a plurality of corresponding pairs; and
a second plurality of conductive traces to provide a shield, a respective one of said second plurality of conductive traces being located on each side of each of said plurality of corresponding pairs of said first plurality of conductive traces;
wherein said first plurality of conductive traces are part of a bus system of said processing system.

31. The processing system according to claim 30, wherein said shield is a ground shield.

32. The processing system according to claim 30, wherein said signals in each of said corresponding pairs are differential signals.

33. A method for constructing a circuit card for a bus system comprising the steps of:
providing a first plurality of pins on a connector of said circuit card, said first plurality of pins for conducting bus signals;
grouping said first plurality of pins into a plurality of corresponding pairs;
providing a second plurality of pins on said connector of said circuit card, said second plurality of pins for providing a signal shield; and
locating a pin of said second plurality of pins adjacent to each side of said corresponding pairs of pins of said first plurality of pins.

34. The method according to claim 33, further comprising:
coupling each of said second plurality of pins to a ground potential.

35. The method according to claim 33, wherein said step of grouping said first plurality of pins further comprises:
grouping said first plurality of pins into a plurality of corresponding pairs, wherein said pins in each corresponding pair are adapted to conduct differential signals.
